(19) United States
(12) Patent Application Publication
(10) Pub. No.: US 2003/0077964 A1
(43) Pub. Date: Apr. 24, 2003

(54) Breathable roofing underlayment

(76) Inventor: Hans-Georg Klein, Radevormwald (DE)

Correspondence Address: Martin A. Farber, Suite 473, 866 United Nations Plaza, New York, NY, 10017, US

(21) Appl. No.: 10/000,900

(22) Filed: Nov. 15, 2001

(30) Foreign Application Priority Data
Nov. 17, 2000 (DE) 100 57 149.2

(51) Int. Cl. B32B 27/04; B32B 5/02; B32B 27/12; D04H 1/00; D04H 13/00

(52) U.S. Cl. 442/149; 442/327; 428/343

(57) ABSTRACT

A brathable roofing underlayment, and method for its production, comprising a sheetlike carrier (1), for example a base nonwoven, which by a membrane (2) applied to the carrier (1) is airflows- and water- tight yet pervious to water vapour, wherein the membrane is a hotmelt adhesive film (2) applied hot directly to the carrier (1).

### The invention relates to a breathable roofing underlayment comprising a sheetlike carrier, for example a base nonwoven, rendered airstream and watertight yet water vapour pervious by a membrane applied to the carrier.

Roofing underlayments are installed in roofs underneath the tiles or other covering materials to additionally protect the insulating materials underneath against moisture, dust, blowing snow and wind. They should also offer very low resistance to moisture (in-built moisture, condensation, leakage moisture) passing through to the outside as water vapour by diffusion. Furthermore, an emergency cover is desirable during the open building phase, and this is actualized by the underlayment too. There are known breathable roofing underlayments which are a single ply product based on an HDPE spunbonded. Also known are products having two or more plies and incorporating a PP or PE film as a membrane. The membrane is bonded thermally to the carrier using an adhesive for example. Also known are two ply products having plastisol coatings based on PUR, PA or copolymers thereof. There are also three ply products comprising polyester or polyester block amide sheeting.

WO 97/30244 shows for example a breathable roofing underlayment and a process for producing same.

It is an object of the present invention to provide a roofing underlayment which is fit for the purpose and simple to produce and also a process for producing same.

This object is achieved by the invention specified in the claims.

Claim 1 achieves the stated object initially and substantially when the membrane is a hotmelt adhesive film applied hot directly to the carrier. According to the invention, a separate adhesive can be dispensed with, since the membrane is formed by the adhesive itself. Unlike in the prior art, however, the hot adhesive is applied as a film to the carrier. Application is effected in the hot state, so that a uniform, intimate bond ensues between the hot adhesive film and the carrier. The carrier is preferably a sheetlike structure which is air pervious or has been rendered air pervious, for example a nonwoven. The carrier can consist of PP, PET or PE. It has been determined that, surprisingly, the mere laminating with the filmlike adhesive provides water vapour transmission rates of more than 120 g/m²/24 hours. The carrier can be a textile nonwoven having a basis weight of 10 to 150 g/m². It is considered particularly advantageous for the hot adhesive film to be pressed into the interstitial spaces in the fissured carrier. This measure increases the water vapour transmission rate by a further factor of 6. It is further advantageous for the hot adhesive to penetrate into the voids in the carrier. The individual fibres of a carrier nonwoven can then be adhered together. The hotmelt adhesive film can be positioned between two water and vapour pervious carrier materials, for example textile nonwovens. One nonwoven then forms a base nonwoven. The other forms a top nonwoven. The material properties of the hotmelt adhesive are preferably chosen so that a surface tension of less than 20 mN/m is obtained. In a further development of the invention, a reinforcing grid can be disposed between the top nonwoven and the hotmelt adhesive film. The top nonwoven or the hotmelt adhesive film can further be covered with metal platelets or glass balloon dust. But it is also possible to aluminize the top nonwoven or the hotmelt adhesive film by the vapour deposition process. Furthermore, the hotmelt adhesive film can have an SAP embedded into it or applied to it on one side, for example extremely expandable, gel-forming and crosslinking acrylic acid polymers.

The invention further provides a process for producing a roofing underlayment by a carrier structure, for example a base nonwoven, having a membrane applied to it continuously. According to the invention, it is provided that the carrier has directly applied to it a slot-extruded film of a hotmelt adhesive. Carrier and film can jointly pass through a nip. The rolls can exert a contact pressure pressing the film into the voids in the carrier. Preferably the rolls may each or both have an embossing structure. In a further development of the invention, a top nonwoven and a reinforcing grid pass into the nip as well as the film and the carrier to produce a multilayer structure.

The invention further provides an insulator which comprises an insulant laminated on one side with a breathable roofing underlayment. According to the invention, the roofing underlayment is a roofing underlayment where the membrane is a hotmelt adhesive film applied hot directly to the carrier, the hotmelt adhesive film being thermally reactivatable.

Embodiments of the invention will now be more particularly described in detail by way of example by reference to accompanying drawings, where

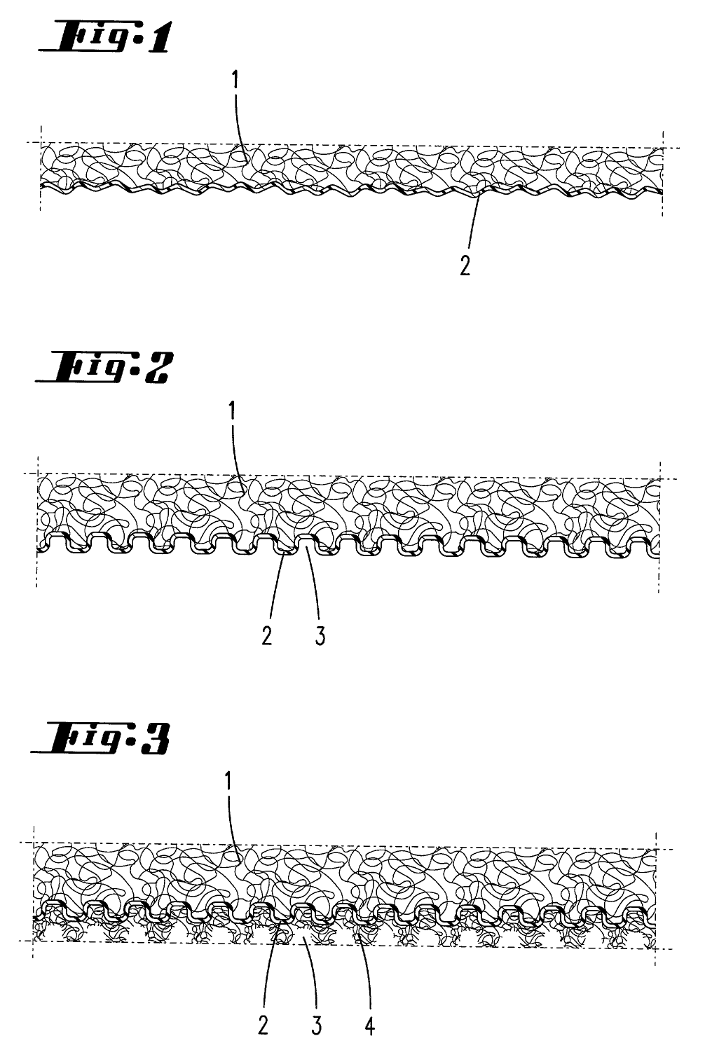

FIG. 1 shows a first illustrative embodiment of an inventive breathable roofing underlayment, roughly schematicized in cross section,

FIG. 2 depicts a second illustrative embodiment as per FIG. 1,

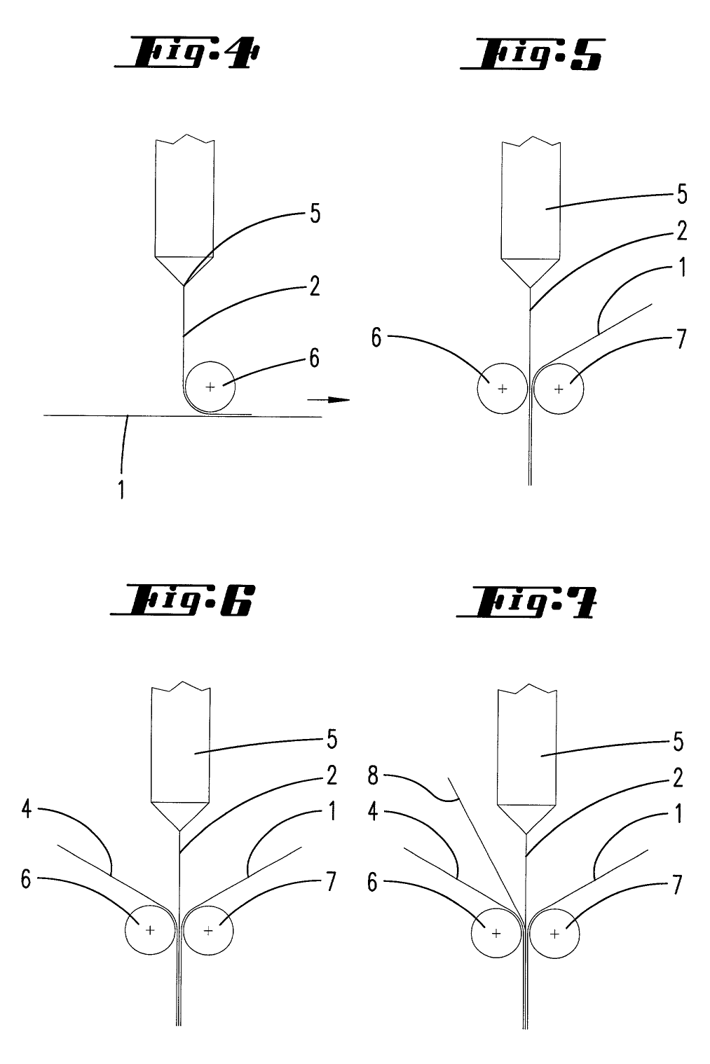

FIG. 3 depicts a third illustrative embodiment as per FIG. 1,

FIG. 4 shows the roughly schematicized depiction of the first production process,

FIG. 5 shows a roughly schematicized depiction of a production process for the second illustrative embodiment,

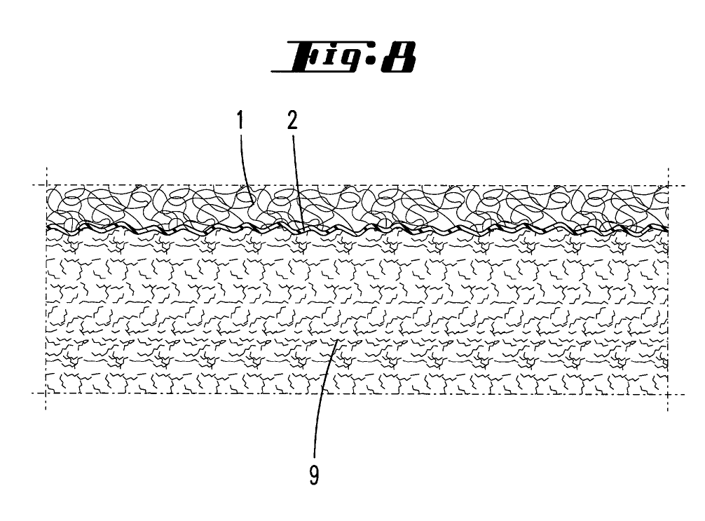

FIG. 6 shows a variation of the production process as per FIG. 5,

FIG. 7 shows a further variation of the production process and

FIG. 8 shows a further illustrative embodiment of a breathable roofing underlayment.

FIG. 1 depicts an illustrative embodiment consisting of a textile carrier nonwoven 1 atop of which a hotmelt adhesive film 2 has been applied directly while the film 2 was still in the hot state. The hotmelt adhesive film 2 may be applied to the base nonwoven in accordance with FIG. 4 for example. Here, the hotmelt adhesive film 2 exits from a slot-shaped extrusion die 5 continuously and is redirected by a roll 6 and laid down on the surface of a base nonwoven 1. The hotmelt adhesive film then adheres to the fibres of the base nonwoven 1 and forms a water vapour pervious yet air and water impervious membrane. The illustrative embodiment depicted in FIG. 1 may have a water vapour transmission rate of more than 120 g/m²/24 hours. The water tightness in such that it resists a hydrostatic head of at least 1 m. It is sufficient for the basis weight of the applied film to be 20 g/m². The applied weight can vary between 5-100 g/m², preferably 10-40 g/m².

FIG. 2 depicts an illustrative embodiment where the base nonwoven 1 possesses depressions 3 or voids. The hotmelt adhesive film 2 penetrates as far as into the depressions 3 or voids 1. Production can be effected using an apparatus schematically depicted in FIG. 5. Here too the hotmelt adhesive film 2 is extruded from an extrusion die 5 in the form of a slot and applied to a base nonwoven 1. This takes place in a nip between two mutually parallel rolls 6, 7 by the base nonwoven 1 and the hot hotmelt adhesive film continuously passing into the nip. The rolls 6, 7 exert contact pressure on the hotmelt adhesive film 2 and the base nonwoven 1 to create an intimate bond between film 2 and base nonwoven 1. When one of the two rolls 6, 7 in this illustrative embodiment is engraved, for example with a bump pattern, the finished roofing underlayment will show depressions 3 into which the hotmelt adhesive film 2 penetrates. Roofing underlayments produced in this way have an appreciably higher water vapour transmission rate in that it can be more than 700 g/m²/24 hours. Even water vapour transmission rates of up to 830 g/m²/24 hours are attainable.

The process described makes it possible to produce roofing underlayments according to the invention where the SD value is <0.3 m coupled with resistance to a hydrostatic head of >2 m. The materials are chosen so that the underlayment has at least normal flammability. The surface tension can be <20 mN/m. This avoids wetting through on contact with wood preservatives containing surfactants. No deterioration in the properties is observed on outdoor weathering for 4 months.

FIG. 3 depicts an illustrative embodiment where, as well as the film 2 and the base nonwoven 1, a top nonwoven 4 passes on the film side into the roll nip, so that the hotmelt adhesive film 2 is positioned between base nonwoven and top nonwoven 4. Top nonwoven and base nonwoven can each be formed by textile nonwovens having basis weights between 10 and 150 g/m².

A further development of the invention may have a reinforcing grid 8 passing into the roll nip together with the top nonwoven. The reinforcing grid 8 is then situated between the top nonwoven 4 and the hotmelt adhesive film 2.

In a further development of the invention, the hotmelt adhesive film can be admixed with metal platelets or aluminium vapour deposition coated. It is also possible to coat the upper, top nonwoven 4 with aluminium by the vapour deposition process.

In a further development of the invention which is not depicted, the roofing underlayment can have a spacer grid adhered to it. This can be accomplished by thermal reactivation of the hotmelt adhesive 2. Such a spacer grid provided with a roofing underlayment can be used for example as a breathable separating layer for standing seam roofs.

Another further development has an SAP (for example extremely expandable, gel-forming and crosslinking acrylic acid polymers) embedded in or applied to the hotmelt adhesive film on one side. It is further provided that glass balloon dust in the form of microballoons (silicates, alkylsilicates) will have been embedded in/applied to the hotmelt adhesive film. This glass balloon dust can be for example fly ash as a waste product from coal burning power stations with slag firing.

FIG. 8 depicts an illustrative embodiment where again a breathable roofing underlayment as per FIG. 2 has been provided with a thermally reactivatable hotmelt adhesive film. This roofing underlayment has been adhered atop an insulant 9 as a result of the hotmelt adhesive film 2 having been reactivated by heating.

All features disclosed are in themselves pertinent to the invention. The disclosure of the application hereby also fully incorporates the disclosure content of the related, accompanying priority documents (copy of the prior application), partly with a view to including features of these documents in claims of the present application.

1. Breathable roofing underlayment comprising a sheetlike carrier, for example a base nonwoven, rendered airstream and water tight yet water vapour pervious by a membrane (2) applied to the carrier (1), characterized in that the membrane is a hotmelt adhesive film (2) applied hot directly to the carrier (1).

2. Breathable roofing underlayment according to one or more of the preceding claims or especially according thereto, characterized in that the hotmelt adhesive film (2) comprises EVA, PA, PVAL, PUR.

3. Breathable roofing underlayment according to one or more of the preceding claims or especially according thereto, characterized in that the carrier comprises PP, PET or PE.

4. Breathable roofing underlayment according to one or more of the preceding claims or especially according thereto, characterized in that the carrier (2) is a textile nonwoven having a basis weight of 10 to 150 g/m².

5. Breathable roofing underlayment according to one or more of the preceding claims or especially according thereto, characterized in that the hotmelt adhesive film (2) has been pressed into interstitial spaces (3) in the carrier (2).

6. Breathable roofing underlayment according to one or more of the preceding claims or especially according thereto, characterized by hotmelt adhesive penetrated into voids in the carrier (2).

7. Breathable roofing underlayment according to one or more of the preceding claims or especially according thereto, characterized by an SD value of <0.3 m for the roofing underlayment.

8. Breathable roofing underlayment according to one or more of the preceding claims or especially according thereto, characterized by a surface tension of <20 mN/m for the hotmelt adhesive film.

9. Breathable roofing underlayment according to one or more of the preceding claims or especially according thereto, characterized by a top nonwoven (4) applied atop the hotmelt adhesive film (2).

10. Breathable roofing underlayment according to one or more of the preceding claims or especially according thereto, characterized in that the hotmelt adhesive film and/or the top nonwoven are admixed with metal platelets or aluminium coated.

11. Breathable roofing underlayment according to one or more of the preceding claims or especially according thereto, characterized by a reinforcing grid (8) applied atop the hotmelt adhesive film (2).

12. Breathable roofing underlayment according to one or more of the preceding claims or especially according thereto, characterized by an SAP embedded in the hotmelt adhesive film (2).

13. Breathable roofing underlayment according to one or more of the preceding claims or especially according thereto, characterized by glass balloon dust embedded in the hotmelt adhesive film.

14. Breathable roofing underlayment according to one or more of the preceding claims or especially according thereto, characterized by a thermally reactivatable hotmelt adhesive film (2) whereby the roofing underlayment can be applied atop a spacer grid or an insulant.

15. Insulator coated on one side with a breathable roofing underlayment comprising a sheetlike carrier, for example a base nonwoven, rendered airstream and water tight yet water vapour pervious by a membrane (2) applied to the carrier, characterized in that the membrane is a hotmelt adhesive film (2) applied hot directly to the carrier (2).

16. Process for producing a roofing underlayment according to any preceding claim by a carrier structure, for example a base nonwoven (2), having a membrane (1) applied to it continuously, characterized in that the carrier (1) has directly applied to it a slot-extruded film (2) of a hotmelt adhesive.

17. Process according to claim 16 or especially according thereto, characterized in that the carrier (1) and the film (2) pass through a roll nip (6, 7).

18. Process according to one or more of the preceding claims or especially according thereto, characterized in that the film (2) is pressed by the nip pressure into the voids (3) in the carrier (1) .

19. Process according to one or more of the preceding claims or especially according thereto, characterized in that the rolls (6, 7) each or both have an embossing structure.

20. Process according to one or more of the preceding claims or especially according thereto, characterized in that a top nonwoven (4) and a reinforcing grid (8) pass into the nip as well as the film (2) and the carrier (1).
